(19) United States
(12) Patent Application Publication
(10) Pub. No.: US 2008/0109283 A1
(43) Pub. Date: May 8, 2008

(54) APPARATUS AND METHOD FOR MIXING BUSINESS INTELLIGENCE AND BUSINESS PROCESS WORKFLOWS

(75) Inventors: Adam BINNIE, Bowen Island (CA); Alexis-Jean Laurent NAIBO, Levallois-Perret (FR); Mark William ALLERTON, Vancouver (CA)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/864,618

(22) Filed: Sep. 28, 2007

Related U.S. Application Data
(60) Provisional application No. 60/864,359, filed on Nov. 3, 2006.
(60) Provisional application No. 60/864,355, filed on Nov. 3, 2006.

(51) Int. Cl. G06Q 10/00; G06F 17/30; G06F 17/40

(52) U.S. Cl. 705/7

(57) ABSTRACT

A computer readable storage medium includes computer executable instructions to receive an action originated from a client application of a business intelligence system. Data providing context about the action is received from the business intelligence system. The action is passed to a business process system or a data source, such that the action is substantially completed within the business process system or the data source.

### CROSS-REFERENCE TO RELATED APPLICATIONS

This application claims benefit, under 35 U.S.C. § 119(e), to the following U.S. provisional patent applications, each of which is incorporated by reference in its entirety: Ser. No. 60/864,459, filed Nov. 3, 2006, entitled “Apparatus and Method for Creating Business Process Workflows within Business Intelligence Systems”; and Ser. No. 60/864,355, filed Nov. 3, 2006, entitled “Apparatus and Method for Mixing Business Intelligence and Business Process Workflow”.

This application is related to the commonly owned and concurrently filed application entitled “Apparatus and Method for Creating Business Process Workflows within Business Intelligence Systems”, Ser. No. ______, filed Sep. 28, 2007.

### BRIEF DESCRIPTION OF THE INVENTION

This invention relates generally to combined computer enabled processes in a business organization. More particularly, this invention relates to interacting with business process systems from within a business intelligence system.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information, content delivery infrastructure systems for delivery and management of reports and analytics, data warehousing systems for cleansing and consolidating information from disparate sources, and data management systems, such as relational databases or On Line Analytic Processing (OLAP) systems used to collect, store, and manage raw data.

A subset of business intelligence tools are reporting tools. There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming and or presenting external data.

A report is specifically designed to facilitate working with external data sources. In addition to information regarding external data source connection drivers, the report may specify advanced filtering of data, information for combining data from different external data sources, information for updating join structures and relationships in report data, and instructions including logic to support a more complex internal data model (that may include additional constraints, relationships, and metadata).

In contrast to a spreadsheet type application, a report generation tool is generally not limited to a table structure but can support a range of structures, such as sections, cross-tables, synchronized tables, sub-reports, hybrid charts, and the like. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets applications generally work within a looping calculation model, whereas report generation tools may support a range of calculation models. Although there may be an overlap in the function of a spreadsheet document and a report document, the applications used to generate these documents contain instructions with express different assumptions concerning the existence of an external data source and different logical approaches to interpreting and manipulating imported data.

Report-to-report navigation allows a link to be created from an element of a source report to another target report. A typical example is linking from a summary report to a detail report, where the summary context is used to “drill” on the detail.

A Business Process (BP) is a series of tasks and outcomes associated with a business activity. A BP is usually the result of a business process design or business process engineering activity. A BP can be implemented using specially designed software, the Business Process System (BPS) category of software. BPS software allows the business processes to be defined on, and be executed by, a computer. The BPS software will either use computer applications to perform business operations or will send messages to people requesting they perform certain tasks. In order to work effectively, a BPS often requires that the underlying software is constructed according to the principles of a service-oriented architecture. Thus, it is often difficult to make a suite of existing legacy systems fit with a BPS. However, a BP can be a combination of people and devices without the need for controlling software. A BP and a BPS are often outside of BI systems.

In view of the forgoing it would be desirable to create a BI tool that can provide an interface to a BP tool or system.

### SUMMARY OF INVENTION

The invention includes a computer readable storage medium with computer executable instructions to receive an action originated from a client application of a business intelligence system. Data providing context about the action is received from the business intelligence system. The action is passed to a business process system or a data source, such that the action is substantially completed within the business process system or the data source.

The invention also includes a computer readable storage medium with computer executable instructions to receive a report from which an action can be invoked. The action is associated with a parameter and data providing context. The action is invoked. The action is processed by a business intelligence system.

The invention also includes a computer readable storage medium with computer executable instructions to receive from a business intelligence system an action. The action originate from a source object in the business intelligence system. Data providing context about the action is received from the business intelligence system. The action is completed.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates a system architecture configured in accordance with an embodiment of the invention.

FIG. 3 illustrates a workflow for invoking an action associated with an embodiment of the invention.

FIG. 4 illustrates processing operations associated with processing an action invocation in accordance with an embodiment of the invention.

FIG. 5 illustrates processing operations for processing parameters associated with an action in accordance with an embodiment of the invention.

FIG. 6 illustrates a GUI including a report within a client application of a BI system in accordance with an embodiment of the invention.

FIG. 7 illustrates the GUI of FIG. 6 and the invocation of an action in accordance with an embodiment of the invention.

FIG. 8 illustrates a GUI depicting the interface to BP application in accordance with an embodiment of the invention.

FIG. 9 illustrates a mobile device with a GUI displaying a report in accordance with an embodiment of the invention.

FIG. 10 illustrates the mobile device of FIG. 9 showing a report generated by an action in accordance with an embodiment of the invention.

FIG. 11 illustrates the mobile device of FIG. 9 showing an action menu in accordance with an embodiment of the invention.

FIG. 12 illustrates a workflow for associating an action with a source object in accordance with an embodiment of the invention.

FIG. 13 illustrates processing operations for creating an action that processes an alert associated with an embodiment of the invention.

FIG. 14 illustrates the relationship between objects in a BI system for an embodiment of the invention.

Like reference numerals refer to corresponding parts throughout the several views of the drawings.

### DETAILED DESCRIPTION OF THE INVENTION

The following terminology is used while disclosing embodiments of the invention:

A BI action is the invocation of a request from a source object in a BI system. The action can be processed by the BI system. The request can be of a predetermined type called a BI action type. A BI action can include logic, code or values. BI actions can be navigation actions and non-navigation actions. A navigation BI action navigates away from the source object upon invocation of the action. For a non-navigation action the BI action is invoked and completed, but the source object remains visible. Examples of actions include escalating a bug, approving a report, and adding a comment to a report element. A BI action can change data, start a workflow with the BI system or start a workflow with a BP system.

A BI action type is an operation involved in a BI context, such as, navigating to a URL, a custom action defined in a BI application or a BP application, and the like.

Context is a set of specialized metadata that is associated with BI tool or a workflow, such as, a workflow in a BP tool. The metadata characterizes the environment and/or meaning of a BI action. Semantically, the metadata can perform many functions including: providing data context, user context, situational context, and describing the amount of trust placed in the source object. Metadata need not uniquely define the source objects, but it differentiates a source object from other objects.

Data context is an information framework associated with a data element. Data context may include report context (i.e., report type, report ID, title, report category, data lineage of a report part or element, data path context, and the like).

User context is an information framework related to a user, such as, authentication details, credentials and identity: logon name, user group, domain, cluster, company, and the like.

Situational context is information about an object, such as, the element selected within a source object, the history of interactions with the source object, and the version of the data in the source object, the target object and the like.

Mapping is the routing of parameters through an action. For example, a mapping may be expressed as param1@TargetObject=field1@SourceObject. Alternatively, the routing can be defined by metadata in a semantic domain and is intelligible to the target object, e.g., param1@TargetObject=NAME and “NAME” is mapped to field1@SourceObject.

Semantic domain is the term for a level of abstraction based on a relational, OLAP, or other data source or a combination of more than one data sources or existing semantic domains. The semantic domain includes data model objects that describe the underlying data source and define dimensions, attributes and measures that can be applied to the underlying data source and data foundation metadata that describes a connection to, structure for, and aspects of the underlying data source. A semantic domain can be used as a level of abstraction to combine partial data sets from any number of original data sources. A semantic domain can be used to provide logical sets to which data can be associated so that data from a wide number of sources can be meaningfully aggregated. Metadata concerning the data, such as a value for data freshness, can also be associated with the data within the logic of a semantic domain. Semantic domain technology is disclosed in the following commonly-owned U.S. Pat. Nos. 5,555,403; 6,247,008; 6,578,027; and 7,181,435, which are incorporated herein by reference.

A source object is an element of a BI system that can create content that can be consumed by another element in the BI system or a BP system. Examples of elements include actions, alerts or reports. Examples of reports include complete reports, sub-reports and report parts that include the combination of smaller parts or elements of the report. These elements include a number field, a text field, a graphic, chart or visualization, an analytic and the like. These reports and report parts can be presented in different presentation formats, such as, aggregations of reports (e.g., dashboards), stand alone report parts, and the like. These reports can be in HTML, XML, RePorT format (RPT) and other file formats. A source object can be associated with user context, data context and situational context. In an embodiment, the data context for a report element includes a data path context. The data path context can be defined in a number of ways including as a report part ID as described in the following, commonly owned patent application, which is incorporated by references herein: “Apparatus and Method for Defining Report Parts”, Ser. No. 11/558,861, filed Nov. 9, 2006.

A target object is an element that can consume content from a source object. The element can be inside of the BI system that includes the source object, such as, a report, report element or action. The element can be outside of the BI system. The target object can be a data source outside the BI system, BP application or another application outside the BI system. In the event the source object is also a target object the final target object is often outside the BI system.

Embodiments of the present invention include techniques for combining business process management with BI systems to extend the domain of BI. This includes, but is not limited to, leveraging a BI system in all parts of an organization to facilitate operations and aid task completion (e.g., task driven BI and BI for task identification). Some embodiments of the present invention extend report-to-report navigation and combine it with context passing. Context (e.g., data context) is passed from the source to the target. This allows for a link between any kind of source object that can provide context to any target which can consume that context.

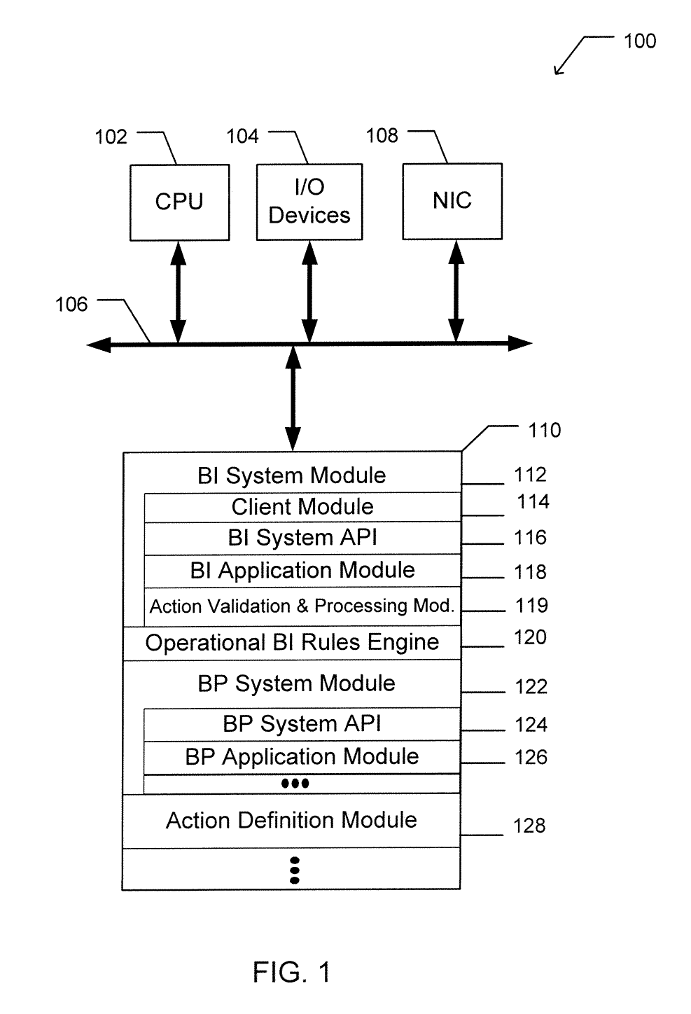

FIG. 1 illustrates a computer 100 configured in accordance with an embodiment of the invention. The computer 100 includes standard components, including a central processing unit (CPU) 102 and input/output devices 104, which are linked by a bus 106. The input/output devices 104 may include a keyboard, mouse, touch screen, monitor, printer, and the like. A network interface circuit 108 is also connected to the bus 106. The network interface circuit 108 provides connectivity to a network (not shown), thereby allowing the computer 100 to operate in a networked environment.

Also connected to the bus 106 is a memory 110. The memory 110 stores executable instructions to implement operations of the invention. In an embodiment, the memory 110 stores the following modules: a BI system module 112, a client module 114, a BI system API module 116, a BI application module 118, an action validation module 119, a rules module 120, a BP system module 122, a BP system API module 124 and a BP application module 126. In another embodiment, memory 110 stores only the non-optional modules: the BI system module 112, the client module 114, the action validation module 119 and the BP system module 122.

The BI system module 112 includes executable instructions to perform BI related functions, such as, generate, view or share reports, perform queries and analyses, and the like. The client module 114 includes executable instructions to interact with other components of the BI system module 112 and provide an interface for the user of the BI system. The client module 114 includes executable instructions to provide an interface to generate, view or share reports. The client module 114 also accepts queries, define and invoke actions. In an embodiment, the client module supports a thick client. In another embodiment, the client module supports a thin client. The BI system API module 116 includes executable instructions to allow other tools and applications to access the BI system. The BI application module 118 includes executable instructions to perform a specific BI function and provide that function as a service. The action validation and processing module 119 includes executable instructions to validate and process actions and their associated parameters. The action validation and processing module 119 can route the action to the appropriate BI application or BP application.

The optional rules module 120 includes executable instructions for ensuring that actions taken by the user, or by executable code stored in computer memory 110, conform to a set of rules established for the BI system or the BP system. The BP system module 122 includes executable instructions to perform BP related functions, such as, define a task, assign a task, begin or continue a task and the like. The BP system API module 124 includes executable instructions to allow other tools and applications to access the BP system. This access includes specifying an interface for accepting actions, context and parameters from the BI system. The BP application module 126 includes executable instructions to perform specific BP functions and provide those functions as a service to the user or a piece of software.

The action definition module 128 includes executable instructions to allow users, system creators and administrators to define actions. These actions are defined for a particular BI system, BI system in combination with a BP system, BI application, plurality of BI applications, and the like. The user, system creator or administrator describes where, when and how an action can be invoked (e.g., source object). They specify the needed context of the action definition. They describe the target object. The vendor of an action definition module could supply kits that include prebuilt actions for a given combination of BI and BP systems.

In some embodiments, the actions are defined before or during association with a report element, i.e., at or before report design time. In an embodiment, the action definition module includes an action definition graphical user interface (GUI), such as, a report design tool, a palette of prebuilt actions, a wizard that guides the creation of actions, and the like. The executable instructions of action definition module 128 allow the user to select an action type and to specify how an action is processed. Users can add new actions types. The instructions allow the user to associate an action with a target object. In an embodiment, a user can add one or more actions to a report. In an embodiment, the action definition module 128 allows a user to select parameters from a semantic metadata layer that overlies a data source provided the action type can determine the context and parameters of the action from the metadata layer. That is, metadata is used to look up, match and map terms from the source and target objects.

The executable modules stored in memory 110 are exemplary. Additional standard modules such as an operating system module or a graphical user interface (GUI) module are included in some embodiments of the invention. It should be appreciated that the functions of the modules maybe combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

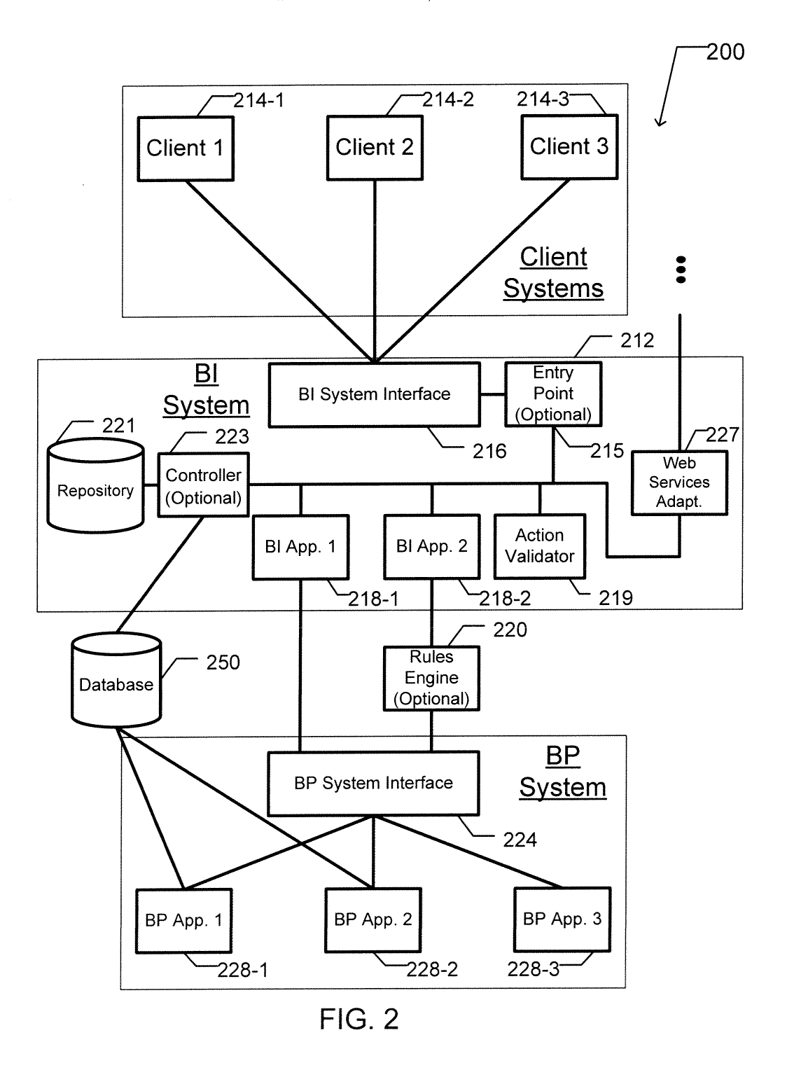

FIG. 2 illustrates network architecture in accordance with an embodiment of the invention. A series of client devices 214-1, 214-2 and 214-3 are coupled to a BI system interface (e.g., an API) 216 executing instructions found in the BI system API module 116 of FIG. 1. The client devices are coupled to the API via a wired or wireless data transmission channel. The client devices each execute instructions from the client module 114 to create a client application. In an embodiment, the client applications are thin, providing only an interface to an application, e.g., a web browser. In an embodiment, the client application are thick, e.g., a BI application connected to a BI system. In an embodiment, the client applications are thick and are primarily for non BI applications, but include a small set of BI tools, e.g., reporting tool within a word processor.

In an embodiment, the client devices 214-1, 214-2, and 214-3 are computers similar to those shown in FIG. 1. The input/output devices of those computers can include input devices such as a keyboard, mouse, and monitor. In addition input/output devices may include input/output devices such as handwriting recognition tablets, touch screen displays, scanners, printers, and the like. Indeed, in an embodiment the client devices 214-1, 214-2, and 214-3 are smaller computing devices, such as, a handheld computer, or another device with computer like features, such as, a cell phone.

The BI system interface 216 provides an interface to a BI system 212. In an embodiment, the BI system includes an optional entry point 215 to which incoming requests from the clients are directed. The entry point defines the BI system controlling access and letting the clients know what applications and services are available in the system. The BI system 212 includes one or more repositories and BI applications. The BI applications 218-1 and 218-2 are attached to a bus. The bus is coupled to a repository 221 (e.g., report repository) through an optional access controller 223. The controller controls access to a data source, e.g., database 250. Also coupled to the bus is a web services adapter 227, such that the BI system can make use of web services when communicating with the client applications.

The BI system module 112 defines the BI system 212 including the entry point 215, access controller 223 and repository 221. The BI application module defines the BI applications 218-1 and 218-2. The executable instructions in the action validation module 119 define an action validator 219. The action validator validates actions and routes the action to the appropriate BI application.

A first BI application 218-1 is coupled to a BP system interface (e.g., an API) 224 for a BP system. The BI application 218-1 executes instructions found in the BI application module 118 of FIG. 1. A second BI application 218-2 is coupled to the interface 224 via an optional rules engine 220. These parallel couplings from BI application 218-1 to interface 224 and BI application 218-2 to interface 224 illustrate two embodiments. In the first embodiment, BI application 218-1 makes a call to the interface 224 directly. In the second embodiment. BI application 218-2 makes a call to the interface 224 via a rules engine. The rules engine parses the call to ensure the contained action and associated date and context conforms to a given set of rules. The interface 224 provides a gateway to one or more BP applications 228-1, 228-2 and 228-3. These applications are selected from one or more BP systems. The BP applications have access to a data source. In an embodiment, the data source is shared with the BI system and is separate from both systems, e.g., database 250.

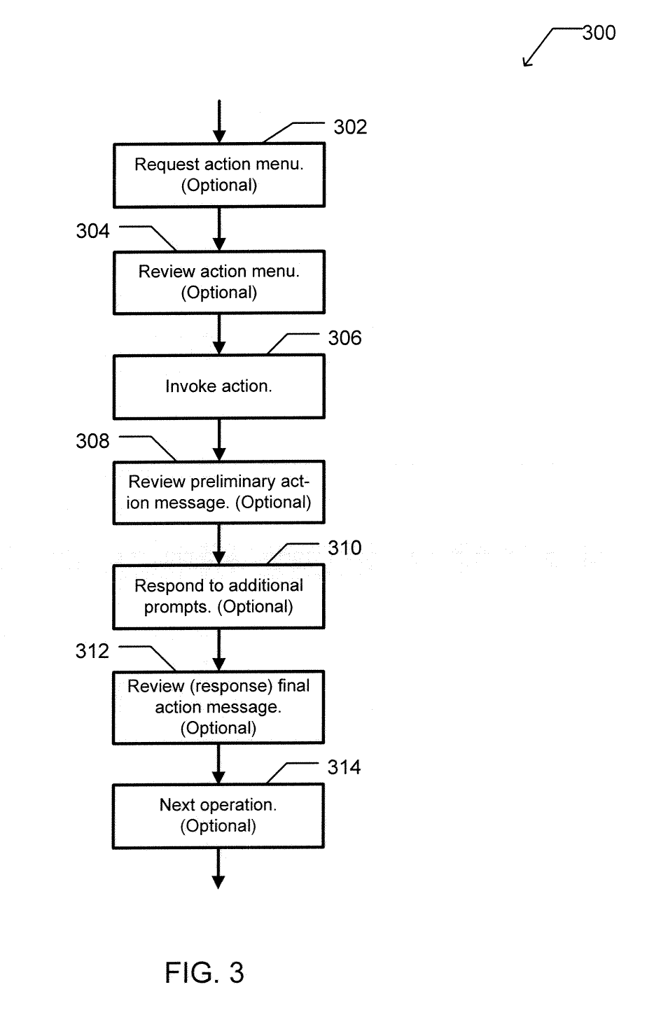

FIG. 3 illustrates a workflow 300 that a user of computer 100 follows while invoking actions from a BI system. In an embodiment, actions appear within a user interface of a client application. For example, the client includes a GUI in which the user reviews a source object, such as a report. The user requests an action menu 302. The user then reviews the action menu 304. The user invokes an action 306. Alternatively, a control, such as a button or a hyperlink is used to invoke the action. If the system gives the user a preliminary action message (e.g., “processing”, “action requested”), the user reviews the preliminary action message 308. Some actions require a set of parameters for the action to be completed. Many of these parameters can be obtained directly from the source object. However, sometimes additional parameters are required and the system prompts the user for them. The user responds to any additional prompts from the system, if any, 310. The final action message (e.g., “action completed”) is then reviewed 312. The processing continues with the next BI operation or BP operation 314. The workflow 300 is an example of how a user interacts with a BP system through a BI system.

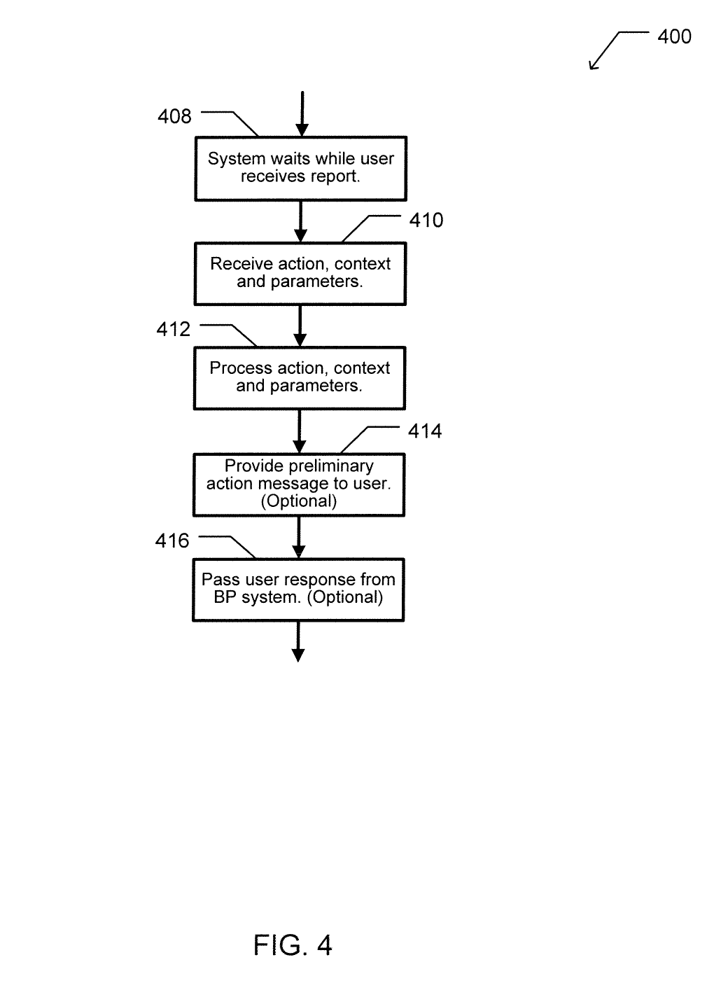

FIG. 4 illustrates a set of processing operations 400 which computer 100 implements while executing instructions from various modules in memory 110. The processing operations 400 represent, in part, the processing operations computer 100 makes in counterpart to workflow 300.

In an embodiment, the user's interaction with the BP system is initiated via an alert in a BI system. The system serves up a report to a user. The user receives the report while the system waits 408. The user in reviewing the report, a section of the report or a sub-report of the report elects to take action. The user takes action by invoking an action that is associated with the report 410. The action and associated context and parameters are processed 412. Optionally, depending on the action, the user is sent a preliminary action message 414. If the action is synchronous, a response may be sent to the user 416. Synchronous actions return a response to the action. Asynchronous actions are actions that do not give a timely response. In an embodiment, the BI system may treat synchronous actions as asynchronous actions for performance reasons. In an embodiment, the synchronous and asynchronous actions are combined.

In an embodiment, the user's interaction with the BI system is extended by including actions in a report where the actions are processed in the BI system. The processing operations 408-412 are valid for this interaction. The action and associated context and parameters are processed within the BI system.

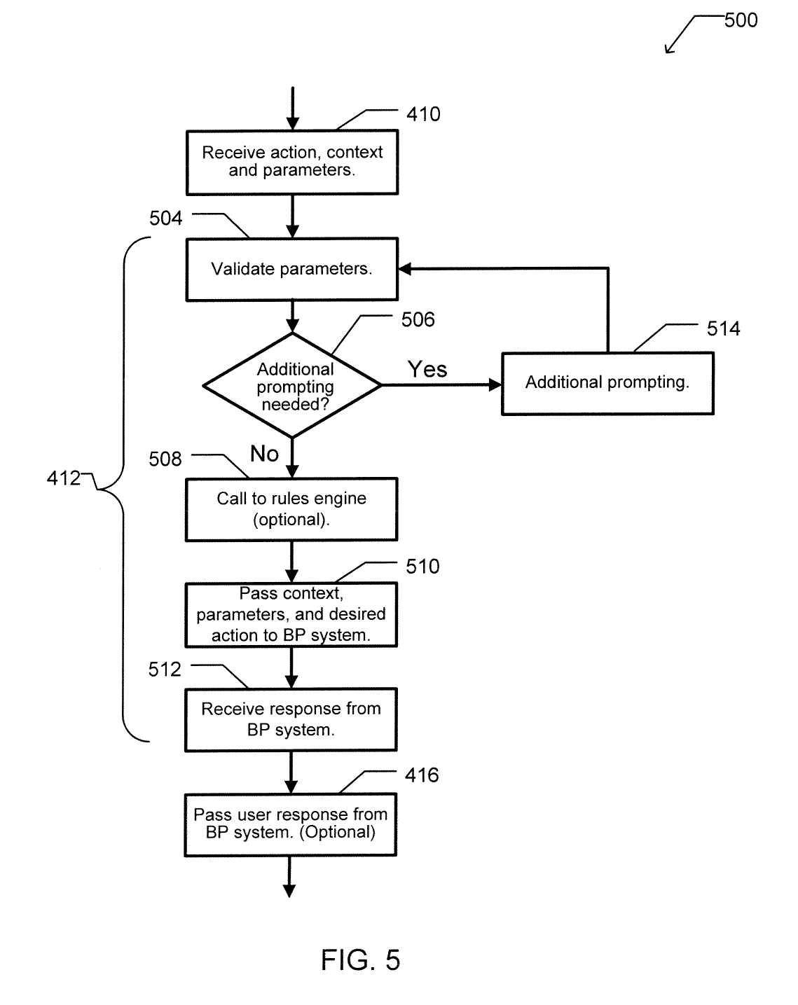

FIG. 5 illustrates a set of processing operations 500 that computer 100 implements while executing instructions from various modules in memory 110. The processing operations 500 are an example of how actions, parameters and context from a BI system are processed and passed to a BP system. The computer 100 receives an action, and the context and parameters associated with the action from a source object 410. A user has invoked the action. The computer 100, executing instructions in the BI system module, validates the parameters for the action 504. The computer 100 determines if more parameters are required or the given parameters are invalid 506. If 506—Yes, there is prompting additional prompting of the user 514. If 506—No, in an embodiment, an optional call to the rules engine is made 508. In another embodiment, if 506—No processing continues with the passing of the action, context and parameters to the appropriate application in BP system 510. The appropriate application is encoded in the action or is determinable from the action and context in operations included in processing operation 510. In an embodiment, operation 510 is where the action is passed from a BI system to a BP system. The BI system receives a response from the BP system 512. In an embodiment, response is relayed, in whole or in part to, the client application 416.

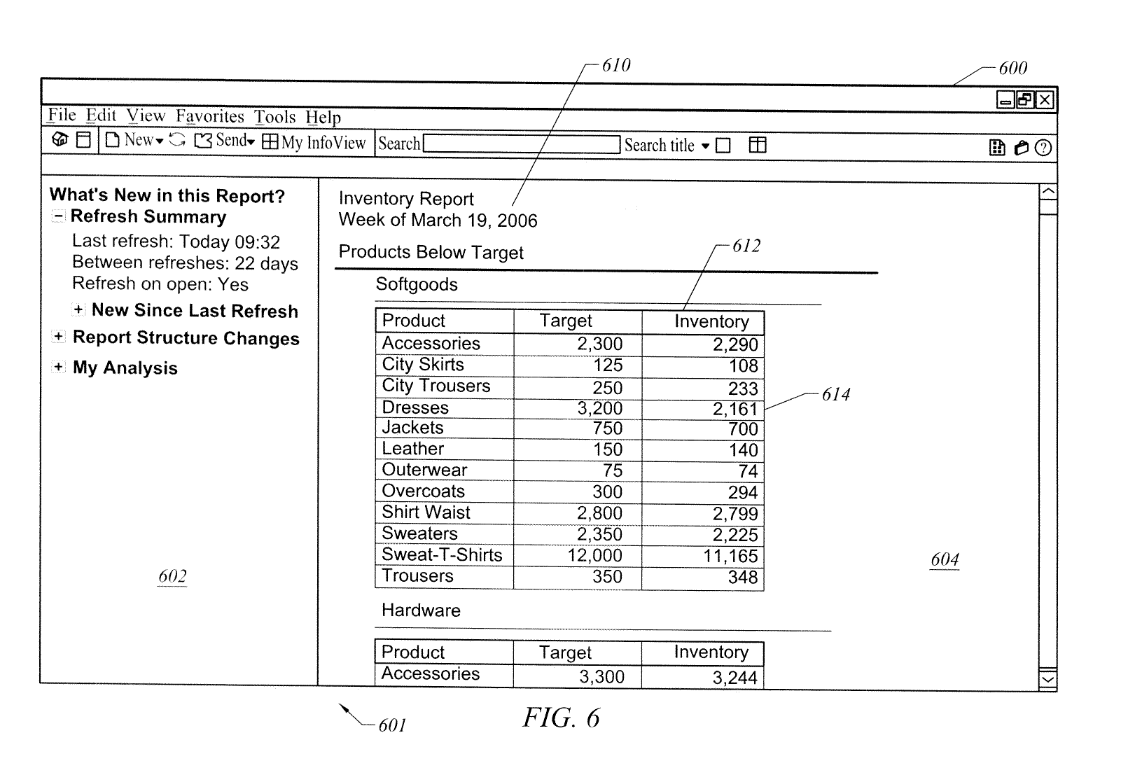

FIGS. 6-8 illustrate the invocation of an action from within a BI application. Specifically FIGS. 6-8 illustrate the invocation of a purchase request on a BP system from within an inventory report, i.e., a source object. FIG. 6 illustrates a GUI 600 including a source object. The source object is an inventory report. The report is displayed in two panes: the side pane 602 and the report pane 604. The side pane 602 provides report context to the user, that is, the consumer of the report. The report title 610 is displayed within the report pane 604. The report illustrated is an inventory report displaying the product, target inventory levels and actual inventory for products whose inventory are below target.

In a normal business process, such a report leads the purchasing agent to purchase, or considering the purchase of, products below target inventory levels. This purchasing can be done by including a purchasing action in the report. The user selects a region of the report, say the table 612 or a row of the table, e.g., “Dresses” 614.

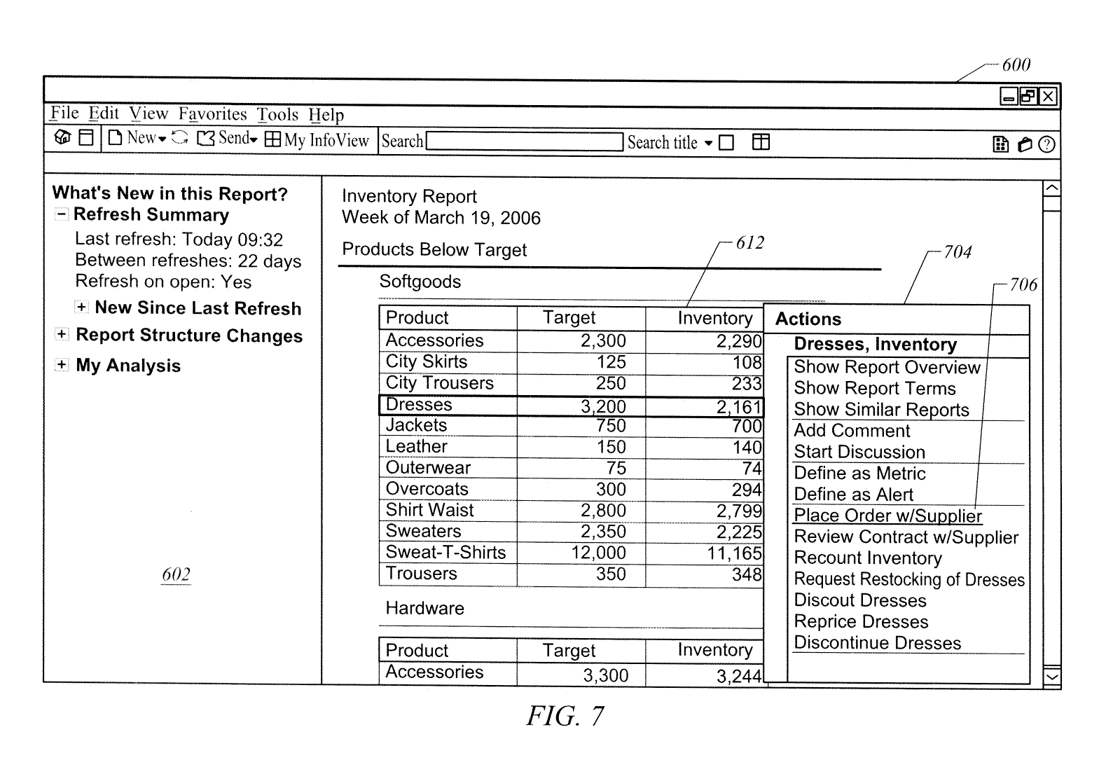

FIG. 7 illustrates the GUI of FIG. 6 where the GUI displays the report and an action menu in accordance with an embodiment of the invention. In an embodiment, the action menu 704 is displayed at the request of a user, for example, by right clicking on a region of a report. In an embodiment, the menu is always displayed. For example, the action menu is displayed in side pane 602 and refreshes as the user interacts with the report.

As illustrated in FIG. 7, the user selects a region of the report, e.g., a row of the table “Dresses”. Selecting “Dresses” can include selecting the context associated with this item such that the data context, in this case a “Softgoods” category and a geographic data context for the data values “America” are also provided and available within an action as either parameters or associated metadata. Contextual information associated with selecting “Dresses” is not limited to data context, but can include user and situational context. The available actions may be filtered based on the context of the source object. The user can then take a number of actions. These actions include placing an order with the supplier of the product, reviewing the contract with the supplier, having the inventory recounted, requesting return (restocking) of the product, discounting the product, discontinuing the product and the like. The user can select and invoke any of these action listed in the menu. For example, the user invokes the “place order” action 706.

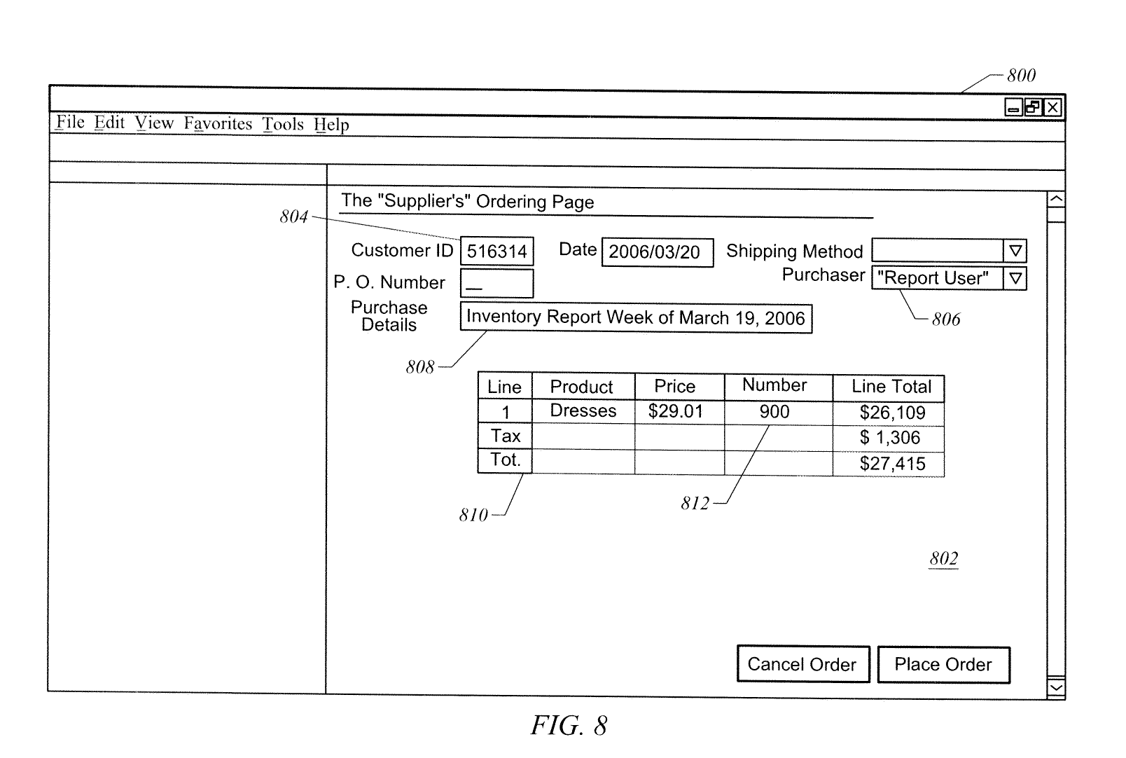

FIG. 8 illustrates a GUI 800 depicting the interface to a BP application in which an action is being executed in accordance with an embodiment of the invention. In this example, the BP application is an ordering application that is presented to the user because the user invoked the “place order” action in the example of FIG. 7. The ordering application is prepopulated with data drawn from the action, parameter, and context defined in the report 601.

The GUI 800 includes the order interface of the supplier ordering system 802. Portions of the order are prepopulated with parameters from the report 601 and the action type. For example, the customer ID 804 is defined in the action type. The name of the purchaser 806 is extracted from the user context. The purchase reason 808 was mapped to the report title by the creator of the action. The name of the product to be ordered is placed in table 810. The amount is prepopulated by the action. However, in one embodiment, the purchaser can override this by typing in a different amount 812. The purchaser can place the order or cancel the order and return to the GUI 600 with the inventory report 601.

In an embodiment of the invention, invoking an action does not redirect the user to the interface of another application. In such an embodiment, the action is completed on the BP system, or other system remote from BI system, directly without a GUI interaction. An example of this is direct data write back to a data source from a report with automated refreshing of the report. This is illustrated in the inventory report of FIG. 6. The user adjusts the inventory on sweaters 650 by typing in a new inventory number within the inventory report. For example, the user types “2,525” in place of “2,225”, because the inventory number is in error and an adjustment needs to be made. This act invokes a write back action. The data source is accessed, the inventory value, or associated adjustment offset, for the relevant record is entered into the data source. The report is refreshed. An action invoked by the user has occurred.

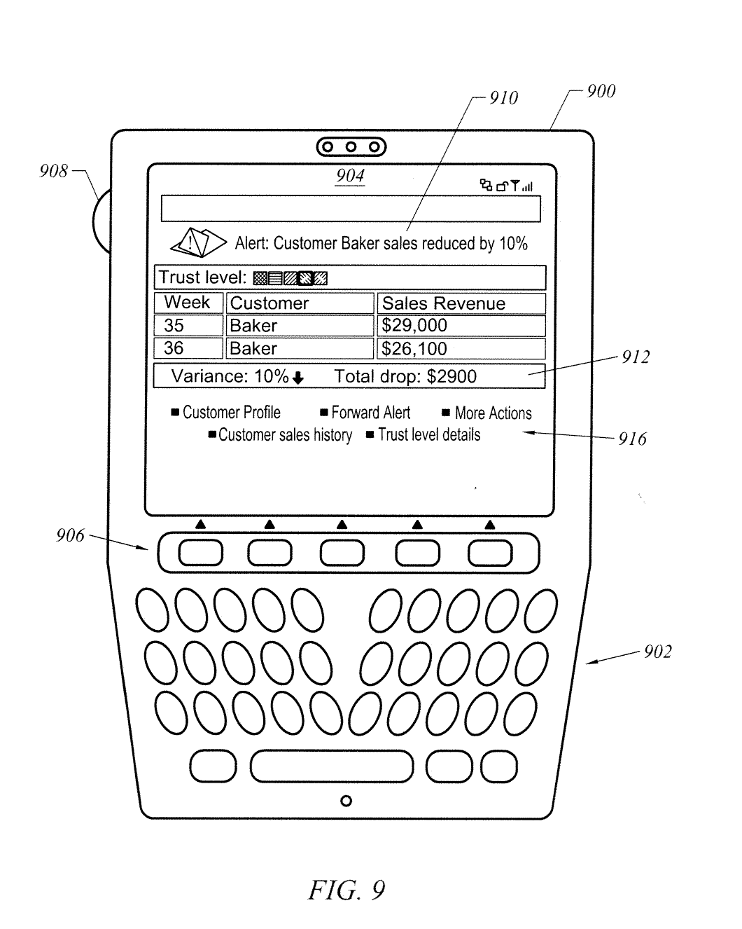

The inventory ordering example of FIGS. 6-8 is continued through FIGS. 9-11. The supplier receives the reduced order made in FIG. 8. The adjustment made results in a lower than expected revenue. This triggers an alert. The alert is processed by sending a report to another user, e.g., an employee of the supplier who has an interest in the revenue from that particular customer. The supplier employee receives the report on a mobile device.

FIG. 9 illustrates a mobile device 900. The mobile device 900 has some components which are similar to those of a computer, for instance, a miniaturized alphanumeric or numeric keyboard 902, display 904, and network interface circuit (not shown). In addition to the keyboard, other input mechanisms are possible, such as, hot keys 906, a thumb wheel 908, a stylus (not shown), a track ball (not shown) and the like. In addition, mobile device 900 need not resemble personal digital assistant it may be another computer like device, such as, a mobile phone.

Within the display 904 of the mobile device 900 is a GUI displaying a report 912. This exemplary report is triggered by an alert and shows the user the fact that customer “Baker” sales have dropped 10%. The user on the mobile device can take action in a number ways. Some of these actions 916 are included in the report and are mapped to the hot keys 906. The actions 916, in the illustrated example, include: retrieving the “customer profile”, retrieving the “customer sales history”, “forward the alert”, retrieving the “trust level details” and “more actions”.

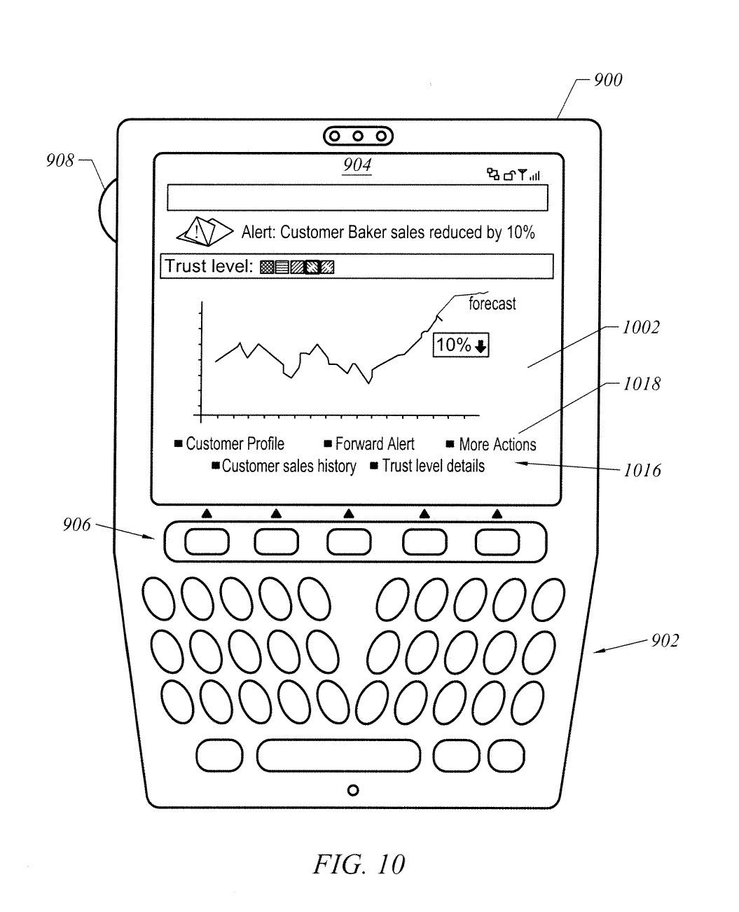

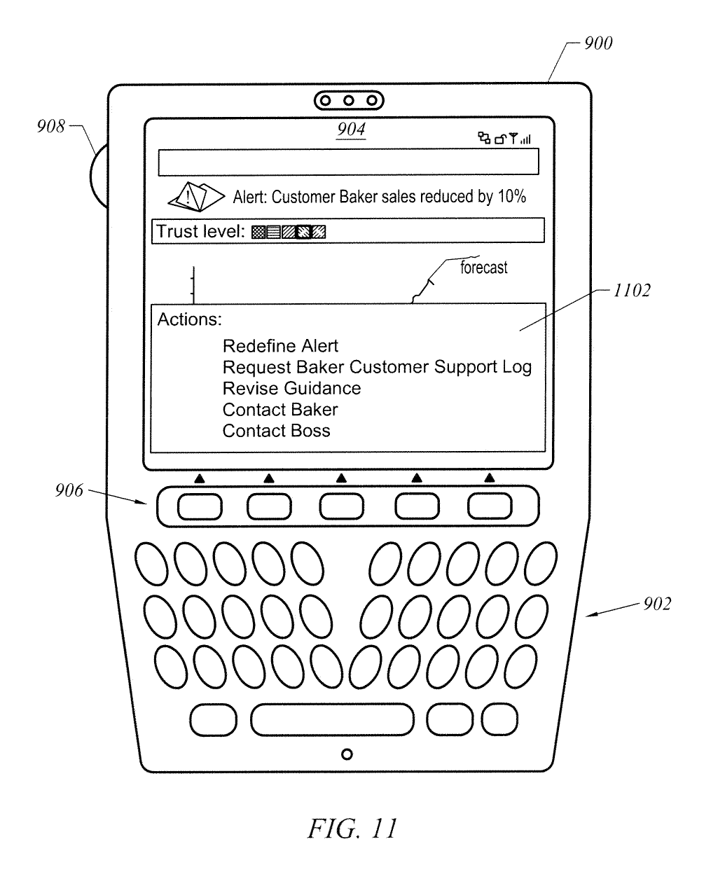

As shown in FIG. 10, the user invokes an action “customer sales history” 1018, while viewing the report. The action generates another report 1002 that is illustrated in FIG. 10. The report 1002 shows the customer history. The user may elect to invoke a further action, e.g., the user selects “more actions” from the list of actions 1016. FIG. 11 illustrates an action menu 1102 in the display 904 of the mobile device 900. The actions in menu 1102 include actions to contact people, gather more information and redefine the alert.

The examples described in conjunction with FIG. 68 and FIGS. 9-11 are exemplary. There are many other examples of use cases for invoking an action from within a BI client. These use cases include: repopulating forms outside the BI system with data from reports, populating forms with data from reports or metadata to the report including context metadata, contacting a person through a business process, accessing a BP system or a non-BI application, sending instructions under a BP to a person or machine, performing data write back to data source outside a BI system, starting a business process to correct an issue detected in a report and the like. These actions are defined by one or more of a user, system vendor and administrator for a particular BI system or a BI system in combination with BP system by executing instructions stored in the action definition module 128.

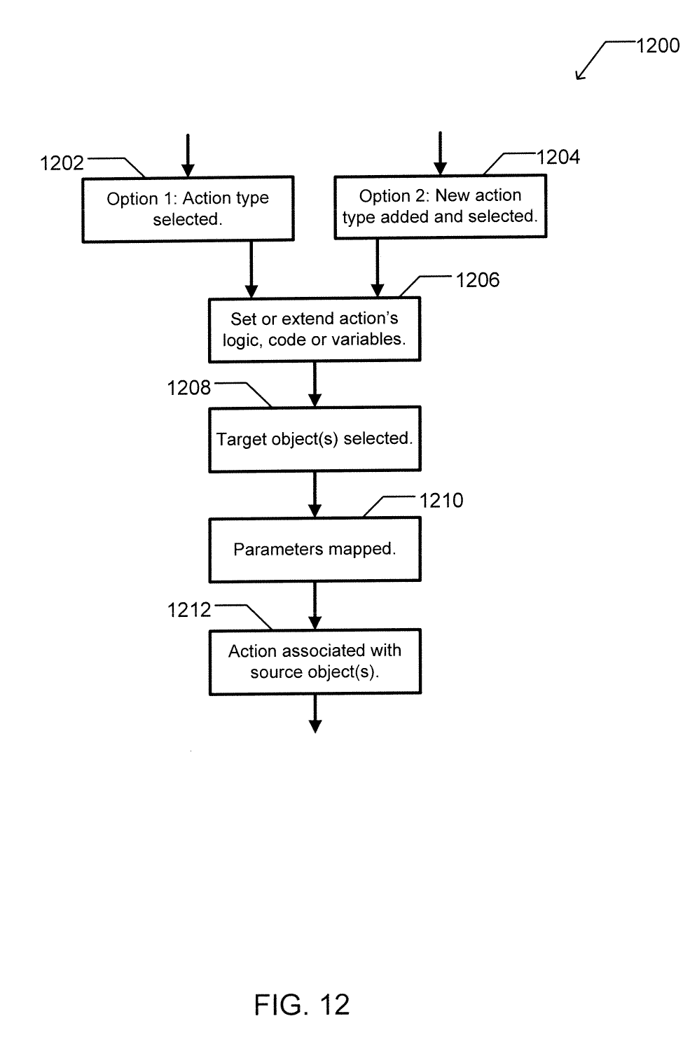

Actions are associated with a source object for a particular BI system by executing instructions stored in the action definition module 128. FIG. 12 illustrates a workflow for including an action in a source object in accordance with an embodiment of the invention. For example, the creator of a report wishes to include an action in the report at report design time. In an embodiment, the user can select a source object before selecting and defining an action. In another embodiment, the action is associated with the source object after the action is defined. The action type is selected 1202. In an embodiment, the action types are selected via a GUI within a report design tool. For example, the action types are stored in a central repository which is queried by the report design tool. Alternatively, if the existing action types are not useful, a new action type is created and selected 1204.

The action type contains logic, code and variables. This logic is used by the BI system to process the action. The logic can be used to determine how the action is processed, how two or more actions depend on each other, or how the action relates to other objects in the BI system. The code is used in the servicing of an action. For example, if the action includes writing to a specific data source then appropriate code is included in the action type. The action type also includes variables. The variable can serve a number of roles including the ID or name of the action, default values to pass to target objects and values that can be consumed by the BI system, code in the action or logic in the action. In operation 1206 of work flow 1200 the logic, code and variables of the action are set. The logic, code and variables, once set, define an action.

The target object for the action is selected 1208. In an embodiment, there are multiple target objects. In an embodiment, the target objects are objects within the BI system such as another report, report element or another action. In another embodiment, the target objects are outside of the BI system and include an API for BP systems, BP applications, data sources and the like. When the target object is outside of the BI system, the BI system can include an object representing the target object. The type of target object is predetermined by the action type. In an embodiment, the types of target objects that can be the target for an action are filtered out of a list of possible targets.

The input parameters needed to process the action are mapped to output parameters 1210. The target object has a series of fields which are completed with output parameters from the action. The output parameters from the action are created from the input parameters to the action. The input parameters come from the fields in the source object, the context of the source object, metadata value for the source object, user input or other variables.

In an embodiment, the parameters mapped from input to output of the action are put through one or more transforms. These transforms are defined by the action type creator or the action creator. These transforms are included in the logic of the action. In an embodiment, the mapping makes use of a semantic domain. If an action contains an input parameter that is based on a semantic domain and the source object is based on the same domain, automatic mapping of fields in the source object to fields in the target object can be achieved. This automated mapping can be altered by the action creator, for example, by inserting a transform into one or more mappings. In an embodiment, the user maps fields in the target object to fields in the source object, the output of field of a transform in the action, static or semi static parameters of the BI system, a metadata value for the source object or a request to prompt the user who invokes the action for the parameter.

In one embodiment, the target system interprets the action message based on a message standard without the action providing explicit parameter mappings. An action's message is the data sent to the target system. The target system servicing the action decodes the message format. In such an embodiment, at design time it is not necessary to explicitly map fields. In an embodiment, more than one target system can consume the message from the source object.

The action is associated with the source object 1212. An example of a source object is a report. In an embodiment, the action is stored in the source object. In another embodiment, a reference to the action is stored in the source object while the action is stored elsewhere. Accordingly, the addition of actions to a report, where the source object for the action is the report or a report element, does not appreciably change the size of the report. An action once defined and stored can be reused. If the action is fully context aware, the input parameters need not be altered. However, in an embodiment it is necessary to alter the input parameters with action reuse.

Embodiments of the present invention allow for a many to many relationship between source objects, actions and target objects. Actions can be associated with more than one source object. In an embodiment, this is done by assigning more than one source action to the source object. An action can have more than one target object. A target object can be associated with one or more source objects.

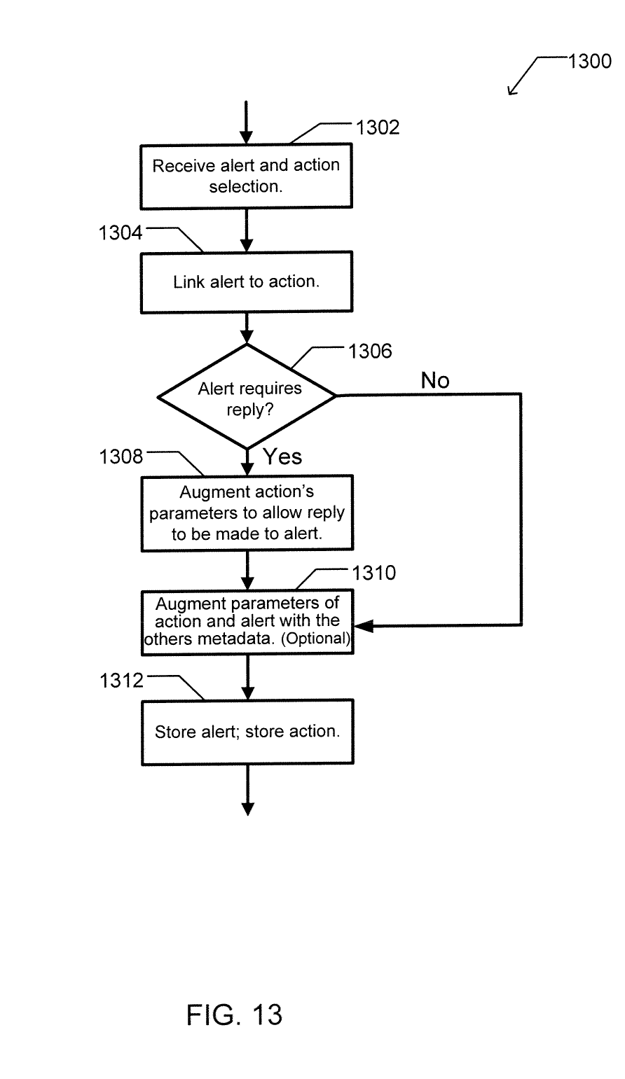

FIG. 13 illustrates processing operations for creating an action that processes an alert associated with an embodiment of the invention. In an embodiment, the computer 100 by executing instructions stored in the action definition module 128 implements processing operations 1300. The computer receives the selection of an alert and the action that will process the alert 1302. The alert and the action are linked 1304. The action and the alert can pass parameters back and forth. The alert is probed to determine if a reply is required 1306. If 1306—Yes, the action's parameters are augmented with metadata to allow replay to an alert 1308. For example, the metadata can include an ID to the alert. After operation 1308 processing continues at 1310. If 1306—No, optionally the parameters of the alert and action are augmented with other metadata. The alert and action are stored 1312.

The processing operations 1300 show how an alert can have one or more actions associated with it. A user, viewing an alert notification based on the alert, will be able to choose which of the one or more actions to perform. The context of an alert includes the data context of the alert. The data context is the parameters that were used to trigger the alert notification.

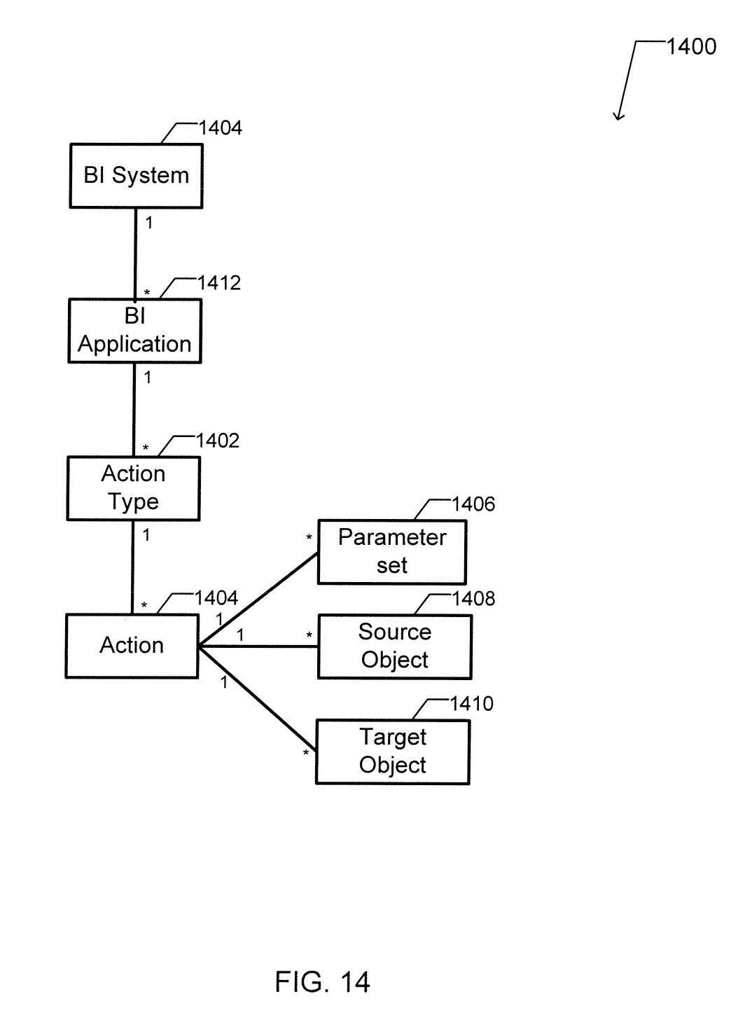

The BI system manages the actions. These actions are associated with source objects when the source objects are (re)designed. The relationship between objects in the BI systems and another system are shown in FIG. 14. In diagram 1400 “1”:“1” denotes one-to-one while “1”:“*” denotes one-to-many. For a BI application there are one or more action types 1402. These action types can have one or more actions 1404 associated with them. An action is an instance of an action type. One or more parameter sets 1406 can be added to the action. In an embodiment, there is a one-to-one relationship between actions 1404 and parameters sets 1406. The actions 1404 are related to one or more source objects 1408. This is a soft link as the source object can be deleted without deleting the corresponding action. The actions are hard linked to their target objects 1410. There can be more than one target object for an action. The BI system also relates action types 1402 to BI applications 1412. One BI application can have many action types.

In an embodiment, the BI system provides the functionality to list all the action types for the BI system. In an embodiment, the action types can be filtered by the BI application they are associated with. The system can return all the properties and relationships of the action types. In an embodiment, the system retrieves the properties and relationships of the action types by examining the metadata associated with the action types and actions. The system can receive the selection of an action type and display a list of actions of that type. The system will permit, subject to authentication, the addition, modification and deletion of action types. In an embodiment, an action can be copied to create a new action.

When introducing elements of embodiments of the invention, the articles “a”, “an”, “the” and “said” are intended to mean that there are one or more of the elements. The terms “comprising”, “including” and “having” are intended to be inclusive and to mean that there may be additional elements other than the listed elements.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising computer executable instructions to:
receive an action originated from a client application of a business intelligence system;
receive data providing context about the action from the business intelligence system; and
pass the action to a target system, such that the action is substantially completed within the target system.

2. The computer readable storage medium of claim 1 further comprising executable instructions to receive a data set from the client application, wherein the data set provides additional context about the client application.

3. The computer readable storage medium of claim 1 further comprising executable instructions to receive a parameter and to validate the parameter in the business intelligence system.

4. The computer readable storage medium of claim 1 further comprising executable instructions to:
receive a response to the action from the target system; and
direct the response to the client application.

5. The computer readable storage medium of claim 1 further comprising executable instructions to apply a set of rules against the action.

6. The computer readable storage medium of claim 1 wherein:
the action has an action type;
the target system is a target object to the action; and
the target object is specified by one or more of the action, the action type, and a parameter.

7. A computer readable storage medium, comprising computer executable instructions to:
receive a report from which an action can be invoked, wherein the action is associated with a parameter and data providing context; and
invoke the action.

8. The computer readable storage medium of claim 7 further comprising computer executable instructions to receive a response to the action from a target system selected from a business process system and a data source.

9. The computer readable storage medium of claim 8 wherein the action is substantially completed within the target system.

10. The computer readable storage medium of claim 7 further comprising executable instruction to define an action menu, wherein the action menu includes the action.

11. The computer readable storage medium of claim 10 further comprising executable instructions to receive the selection of the action from one or more actions displayed within the action menu.

12. The computer readable storage medium of claim 7 wherein the action is invoked by a user interface gesture that is used to invoke report navigation.

13. The computer readable storage medium of claim 7 wherein the data providing context is metadata within the business intelligence system.

14. The computer readable storage medium of claim 7 wherein the data providing context is metadata to the report.

15. The computer readable storage medium of claim 7 wherein the report is selected from a complete report, a report part, a sub-report and an aggregated report.

16. The computer readable storage medium of claim 7 wherein the action is associated with one or more report elements selected from a number field, a text field, a graphic, a chart, a table, a visualization and an analytic.

17. The computer readable storage medium of claim 7 wherein the report is received as part of an alert notification.

18. The computer readable storage medium of claim 7 further comprising executable instruction to refresh the report upon completion of the action.

19. The computer readable storage medium of claim 7 further comprising executable instruction to:
receive a request for a value from the business intelligence system;
prompt a user for the value; and
respond with the value.

20. A computer readable storage medium, comprising computer executable instructions to:
receive from a business intelligence system an action, wherein the action originated from a source object in the business intelligence system;
receive data providing context about the action from the business intelligence system; and
complete the action in a target system outside the business intelligence system.

21. The computer readable storage medium of claim 20 wherein the action is substantially completed within the target system.

22. The computer readable storage medium of claim 20 further comprising executable instructions to receive a parameter from the source object.

23. The computer readable storage medium of claim 20 wherein the data providing context includes context selected from one or more of data context, user context and situational context.

24. The computer readable storage medium of claim 21 further comprising executable instructions to send a response from the target system to the business intelligence system.

25. The computer readable storage medium of claim 22 further comprising executable instructions to insert the parameter as a value within a business process.
